(19) United States
(12) Patent Application Publication
(10) Pub. No.: US 2026/0142457 A1
(43) Pub. Date: May 21, 2026

(54) PARALLEL ACCELERATED SOLUTION METHOD FOR POST-DISASTER RESTORATION OF POWER SYSTEM BASED ON QUANTUM COMPUTING

(71) Applicant: Xi'an Jiaotong University, Xi'an (CN)

(72) Inventors: Haipeng Xie, Xi'an (CN); Wei Fu, Xi'an (CN); Yu Xin, Xi'an (CN); Chen Chen, Xi'an (CN); Zhaohong Bie, Xi'an (CN)

(73) Assignee: Xi'an Jiaotong University, Xi'an (CN)

(21) Appl. No.: 19/391,925

(22) Filed: Nov. 17, 2025

(30) Foreign Application Priority Data
Nov. 15, 2024 (CN) 202411636465.6

(51) Int. Cl. H02J 3/00; G06N 10/60

(52) U.S. Cl. CPC H02J 3/001; G06N 10/60

(57) ABSTRACT

The present application relates to the technical field of power system operation control, and specifically to a parallel accelerated solution method for post-disaster restoration of a power system based on quantum computing, including: step 1: establishing a model for post-disaster restoration; step 2: according to the quantum proxy Lagrangian relaxation algorithm, decomposing an original optimization problem into node subproblems; and step 3: solving the model for post-disaster restoration, updating Lagrange multipliers and penalty factors in iteration, achieving an optimal solution under the interaction of quantum computing and classical computing, and accelerating the acquisition of a restoration plan to guide a safe operation of the power system. The present application decomposes a problem into subproblems and divides the subproblems into discrete and continuous parts for solution, reducing the difficulty. The effects of parallel computing and quantum-embedding accelerated computing are realized without complete optimization for a relaxed problem, ensuring better convergence.

### RELATED APPLICATIONS

The present application claims the benefit of priority of Chinese Patent Application No. 2024116364656, filed Nov. 15, 2024, and entitled “PARALLEL ACCELERATED SOLUTION METHOD FOR POST-DISASTER RESTORATION OF POWER SYSTEM BASED ON QUANTUM COMPUTING” the entire content of which is incorporated herein by reference.

### TECHNICAL FIELD

The present application relates to the technical field of power system operation control, and specifically to a parallel accelerated solution method for post-disaster restoration of a power system based on quantum computing.

### BACKGROUND

After an extreme disaster occurs, it is important for a power system to quickly restore the power supply following the damage caused by the disaster. Rational and efficient dispatch and control, and coordinated optimization are the basis for ensuring the safe and stable operation of a power grid. With the expansion of the power system, the complexity and computational burden of optimization problems increase sharply, requiring faster and more efficient solution techniques to address these challenges.

Quantum computing adopts “qubit” as the basic information unit and harnesses principles such as quantum superposition and entanglement for parallel computing. Quantum computing can achieve exponential acceleration for some specific optimization problems and is an important direction for future computing development. Currently, quantum computing hardware includes a gate-based quantum computer, a dedicated quantum computer (such as a coherent Bose quantum computer, a coherent Ising machine, and a quantum annealing computer), and a quantum simulator based on a classical computer. Although quantum hardware has entered the era of Noisy Intermediate-Scale Quantum (NISQ), the number of qubits in a quantum processor is limited, and substantial effort is required to achieve large-scale fault-tolerant universal quantum computing.

The current exploration of quantum computing applications mainly includes four aspects: quantum combinatorial optimization, quantum parameter prediction, quantum artificial intelligence, and quantum linear algebra operations. Quantum combinatorial optimization aims to find the optimal solution among many possible solutions with higher efficiency and accuracy. Currently, the available quantum optimization algorithms include the quantum approximate optimization algorithm, the variational quantum eigensolver, and Grover's algorithm. However, due to the limitations of NISQ hardware and software, these algorithms cannot directly solve a large-scale optimization problem. A solution mode that adapts to the current development status is hybrid quantum classical computing, in which a global optimization problem can be decomposed into subproblems solved interactively by a classical computer and a quantum computer.

For optimization problems of post-disaster restoration of the power system, most of them belong to a mixed-integer linear programming model. In order to effectively leverage the advantages of quantum computing, two technical ideas are provided. The first is to expand the scale of quantum hardware. Achieving this goal requires major technical and engineering advances in quantum hardware. Although a quantum annealing computer has been directly applied to solve commercial optimization problems, scalability limitations still remain. Another idea is to effectively leverage decomposition and coordination algorithms. In recent years, scholars at home and abroad have studied the application of decomposition algorithms in the power system, such as the alternating direction method of multipliers, the proxy Lagrangian relaxation method, and the Benders decomposition algorithm. Existing studies have made preliminary attempts to explore practical problems such as distributed unit combination of the power system, day-ahead dispatching optimization, grid reconstruction, and energy management of power systems. It has been verified from theory and experiment that quantum computing has the potential to accelerate computing, indicating a promising future that still requires further exploration.

However, in the above existing studies, the use of the alternating direction method of multipliers to solve an original optimization problem may encounter non-convergence, while the Benders decomposition algorithm and proxy Lagrangian relaxation method will have slow convergence speed to varying degrees. These issues affect the efficiency of solving optimization problems of post-disaster restoration of the power system. In addition, existing research on quantum computing in the power field lacks detailed consideration of unit modeling and power line transmission constraints. The model scalability and adaptability need to be adjusted.

Therefore, a solution method of high efficiency, low difficulty, and good convergence is needed to solve the above technical problems.

### SUMMARY

The technical solution employed by the present application to solve the technical problem is: a parallel accelerated solution method for post-disaster restoration of a power system based on quantum computing, including the following steps:

Step 1: Establish a basic model for post-disaster restoration of the power system, in which the basic model includes: a post-disaster restoration objective function, a system balance and load constraint model, an electric power transmission constraint model, and a generator unit operation constraint model;

Step 2: According to the quantum proxy Lagrangian relaxation algorithm, decompose an original optimization problem into each node subproblem. In the each node subproblem, first construct a discrete optimization part into a quantum model for solution, and then pass a discrete variable solution value to a continuous optimization part for solution; and

Step 3: Use the quantum proxy Lagrangian relaxation algorithm to solve a post-disaster restoration model, continuously update, in an iteration process, a Lagrange multiplier, a penalty factor, and intermediate variable optimization results of discrete optimization and continuous optimization subproblems, achieve an optimal solution under interactive computation of quantum computing and classical computing, and accelerate an acquisition of a post-disaster restoration plan to guide an actual safe operation of the power system.

Preferably, in the step 1, the post-disaster restoration objective function is:

$$min {\sum }_{t ∈ T} {\sum }_{i ∈ B} {C}_{i , t}^{L S} {w}_{i} {R}_{i , t}^{L S} + {\sum }_{t ∈ T} {\sum }_{i ∈ B} {\sum }_{g ∈ {G}_{i}} {C}_{g , t}^{G} {P}_{g , t}^{G} + {\sum }_{t ∈ T} {\sum }_{i ∈ B} {\sum }_{g ∈ {G}_{i}} {C}_{g , t}^{UC} \vert {u}_{g , t} - {u}_{g , t ⊣} \vert \qquad ( 1 )$$

In formula (1), T represents a time period set, u_{g,t} represents an on-off 0/1 state variable of unit g at time t,

$${P}_{g , t}^{G}$$

represents an active output power of unit g at time t,

$${C}_{g , t}^{G}$$

represents an active load shedding of node i at time t,

$${P}_{i , t}^{L S}$$

represents a unit operating cost of unit g at time t,

$${C}_{g , t}^{U C}$$

represents a unit on-off cost of unit g at time t,

$${C}_{i , t}^{L S}$$

represents a unit load shedding cost of node i at time t, B represents a power system node set, and Gᵢ represents a set of generator units contained under node i. The post-disaster restoration objective function specifically includes three parts: The first item is the load shedding cost, the second item is the generator unit operating cost, and the third item is the generator unit on-off cost. The model aims to minimize the sum of these three costs.

Preferably, in the step 1, the system balance and load constraint model is:

$${\sum }_{i ∈ B} {\sum }_{g ∈ {G}_{i}} {P}_{g , t}^{G} = {\sum }_{i ∈ B} ( {P}_{i , t}^{L} - {P}_{i , t}^{L S} ) , t ∈ T \qquad ( 2 )$$

$$0 \leq {R}_{i , t}^{L S} \leq {P}_{i , t}^{L} , ∀ i ∈ B , t ∈ T \qquad ( 3 )$$

In formula (2) and formula (3),

$${P}_{i , t}^{L}$$

represents an active load of node i at time t; and formula (2) is a system power balance model, and formula (3) is a node load shedding model.

Preferably, in the step 1, the electric power transmission constraint model is:

$$- {z}_{ij , t} {S}_{ij}^{max} \leq {P}_{ij , t} \leq {z}_{ij , t} {S}_{ij}^{max} , ∀ ( i , j ) ∈ L , t ∈ T \qquad ( 4 )$$

$$- ( 1 - {z}_{ij , t} ) M \leq {P}_{ij , t} - ( {θ}_{i , t} - {θ}_{j , t} ) / {X}_{ij} \leq ( 1 - {z}_{ij , t} ) M , ∀ ( i , j ) ∈ L , t ∈ T \qquad ( 5 )$$

$${θ}_{i , min} \leq {θ}_{i , t} \leq {θ}_{i , max} , ∀ i ∈ B , t ∈ T \qquad ( 6 )$$

$${\sum }_{g ∈ {G}_{i}} {P}_{g , t}^{G} - ( {P}_{i , t}^{L} - {P}_{i , t}^{L S} ) = {\sum }_{j ∈ L ( i , j )} {P}_{ji , t} - {\sum }_{j ∈ L ( j , i )} {P}_{ji , t} , ∀ i ∈ B , t ∈ T \qquad ( 7 )$$

In formulas (4)-(7), P_{ij,t} and

$${S}_{ij}^{max}$$

represent an active power and maximum transmission power passing through branch ij, M represents a sufficiently large constant, Xᵢⱼ represents reactance of branch ij, θᵢ, θ_{t,min}, and θ_{t,max} represent a phase angle amplitude, minimum phase angle value, and maximum phase angle value of node i, respectively, z_{ij,t} represents the operating state of transmission branch ij at time t, and j∈L (i, j) represents that node j has node i in an upstream node set of node j. Formula (4) is a power transmission upper and lower limit constraint model of a power line, formula (5) is a power flow constraint model of line ij, formula (6) is a node phase angle upper and lower limit constraint model, and formula (7) is a node power balance constraint model.

Preferably, the generator unit operation constraint model is:

$${u}_{g , t} {P}_{g , min}^{G} \leq {P}_{g , t}^{G} \leq {u}_{g , t} {P}_{g , max}^{G} , ∀ g ∈ {G}_{i} , i ∈ B , t ∈ T \qquad ( 8 )$$

$${P}_{g , t}^{G} - {P}_{g , t - 1}^{G} \leq {RU}_{g} {u}_{g , t - 1} + {RSU}_{g} {y}_{g , t} , ∀ g ∈ {G}_{i} , i ∈ B , t ∈ T \qquad ( 9 )$$

$${P}_{g , t - 1}^{G} - {P}_{g , t}^{G} \leq {RD}_{g} {u}_{g , t} + {RSD}_{g} {z}_{g , t} , ∀ g ∈ {G}_{i} , i ∈ B , t ∈ T \qquad ( 10 )$$

$${y}_{g , t} - {z}_{g , t} = {u}_{g , t} - {u}_{g , t - 1} , ∀ g ∈ {G}_{i} , i ∈ B , t ∈ T \qquad ( 11 )$$

$${y}_{g , t} + {z}_{g , t} \leq 1 , ∀ g ∈ {G}_{i} , i ∈ B , t ∈ T \qquad ( 12 )$$

$${\sum }_{k = t}^{t + {T}_{g , on} - 1} {u}_{g , k} \geq {T}_{g , on} {y}_{g , t} , ∀ g ∈ {G}_{i} , i ∈ B , t ∈ \{ 1 , 2 , … , T - {T}_{g , on} + 1 \} \qquad ( 13 )$$

$${\sum }_{k = t}^{t + {T}_{g , off} - 1} ( 1 - {u}_{g , k} ) \geq {T}_{g , off} {z}_{g , t} , ∀ g ∈ {G}_{i} , i ∈ B , t ∈ \{ 1 , 2 , … , T - {T}_{g , off} + 1 \} \qquad ( 14 )$$

$${\sum }_{t ∈ T} {y}_{g , t} \leq {y}_{g , max} , ∀ g ∈ {G}_{i} , i ∈ B \qquad ( 15 )$$

$${\sum }_{t ∈ T} {z}_{g , t} \leq {z}_{g , max} , ∀ g ∈ {G}_{i} , i ∈ B \qquad ( 16 )$$

In formulas (8)-(16),

$${P}_{g , min}^{G} and {P}_{g , max}^{G}$$

represent maximum and minimum values of output of unit g, respectively, RU_{g}, RD_{g} represent ramp rates of power increase/decrease during normal operation of generator unit g, respectively, RSU_{g}, RSD_{g}, represent on/off ramp rates of unit g, respectively, y_{g,t}, z_{g,t} represent on/off action variables of unit g at time t, respectively, y_{g,min}, z_{g,max} represent the maximum number of on/off actions of unit g, respectively, and T_{g,on} and T_{g,off} represent a minimum on duration and minimum off duration of unit g, respectively. Formula (8) is an upper and lower limit constraint model of generator unit output, formula (9) and formula (10) are ramping constraint models of the generator unit, and formula (11) to formula (16) are operating state constraint models of the generator unit.

Preferably, in the step 2, the original optimization problem is decomposed into each node subproblem, specifically as follows:

The original optimization problem will be decomposed into subproblems represented by the following nodes:

$${{{min}_{{P}_{i , t}^{LS} , {P}_{g , t}^{G}}}_{{u}_{g , t} , {y}_{g , t} , {z}_{g , t}}}_{{P}_{ij , t} , {θ}_{i , t}} \{ \begin{matrix}{\sum }_{t ∈ T} {C}_{i , t}^{LS} {w}_{i} {P}_{i , t}^{LS} + {\sum }_{t ∈ T} {\sum }_{g ∈ {G}_{i}} {C}_{g , t}^{G} {P}_{g , t}^{G} + \\ {\sum }_{t ∈ T} {\sum }_{g ∈ {G}_{i}} {C}_{g , t}^{UC} \vert {u}_{g , t} - {u}_{g , t - 1} \vert + \\ {\sum }_{t ∈ T} {λ}_{t}^{k} {g}_{t}^{k} ( {P}_{g , t}^{G} , {P}_{i , t}^{LS} ) + \frac{{c}^{k}}{2} {\sum }_{t ∈ T} {q}_{t} + \\ {c}^{P} {\sum }_{t ∈ T ij ∈ L} {\sum }_{( i , j ) ⋃ L ( j , , i )} ( {P}_{ij , t}^{i , k} - ( {P}_{ij , t}^{i , k - 1} + {P}_{ij , t}^{j , k - 1} ) / 2 )\end{matrix} \} \qquad ( 17 )$$

$$s . t . Generator unit operation constraint ( 3 ) , ( 7 ) , ( 8 ) - ( 16 ) t ∈ T$$

$$Electric power transmission constraint ( 4 ) - ( 6 ) , ∀ ( i , j ) ∈ L , t ∈ T - {q}_{t} \leq {g}_{t}^{k} ( {P}_{g , t}^{G} , {P}_{i , t}^{LS} ) \leq {q}_{t} , t ∈ T$$

$${g}_{t}^{k} ( {P}_{g , t}^{G} , {P}_{i , t}^{LS} ) = {\sum }_{g ∈ {G}_{i}} {P}_{g , t}^{G , k} - ( {P}_{i , t}^{L} - {P}_{i , t}^{LS , k} ) + {\sum }_{{i}^{′} ∈ {B}_{- i}} {\sum }_{g ∈ {G}_{{i}^{′}}} {P}_{g , t}^{G , k - 1} - {\sum }_{{i}^{′} ∈ {B}_{- i}} ( {P}_{{i}^{′} , t}^{L} - {P}_{{i}^{′} , t}^{LS , k - 1} ) , t ∈ T \qquad ( 18 )$$

In formula (17) and formula (18),

$${λ}_{t}^{k}$$

represents a Lagrange multiplier corresponding to time t under a k-th iteration, qₜ represents a continuous variable added by a relaxation term at time t, c^{k} and c^{P} represent penalty term coefficients, respectively, and

$${g}_{t}^{k} ( {P}_{g , t}^{G} , {P}_{t , t}^{LS} )$$

represents the relaxation term in formula (18).

More preferably, in the step 2, the discrete optimization part is constructed into a quantum model for solution, specifically as follows:

An optimization model with a constraint is reconstructed into a Quadratic Unconstrained Binary Optimization model, and the constraint is converted into multiple penalty terms in the objective function, specifically as follows:

$${H}_{1 , i , t} = {\sum }_{g ∈ {G}_{i}} {C}_{g , t}^{UC} ( {u}_{g , t} + {u}_{g , t - 1} - 2 {u}_{g , t} {u}_{g , t - 1} ) \qquad ( 19 )$$

$${H}_{2 , i , t} = {P}_{2} {\sum }_{g ∈ {G}_{i}} {( {u}_{g , t} {P}_{g , min}^{G} - {P}_{g , t}^{G} + {ξ}_{\underline{1 ,} g , t} )}^{2} \qquad ( 20 )$$

$${H}_{3 , i , t} = {P}_{3} {\sum }_{g ∈ {G}_{i}} {( {P}_{g , t}^{G} - {u}_{g , t} {P}_{g , max}^{G} + {ξ}_{\overline{1 ,} g , t} )}^{2} \qquad ( 21 )$$

$${H}_{4 , i , t} = {P}_{4} {\sum }_{g ∈ {G}_{i}} {( {P}_{g , t}^{G} - {P}_{g , t - 1}^{G} - {RU}_{g} {u}_{g , t - 1} - {RSU}_{g} {y}_{g , t} + {ξ}_{2 , g , t} )}^{2} \qquad ( 22 )$$

$${H}_{5 , i , t} = {P}_{5} {\sum }_{g ∈ {G}_{i}} {( {P}_{g , t - 1}^{G} - {P}_{g , t}^{G} - {RD}_{g} {u}_{g , t} - {RSD}_{g} {z}_{g , t} + {ξ}_{3 , g , t} )}^{2} \qquad ( 23 )$$

$${H}_{6 , i , t} = {P}_{6} {\sum }_{g ∈ {G}_{i}} {( {y}_{g , t} - {z}_{g , t} - {u}_{g , t} + {u}_{g , t - 1} )}^{2} \qquad ( 24 )$$

$${H}_{7 , i , t} = {P}_{7} {\sum }_{g ∈ {G}_{i}} ( {y}_{g , t} {z}_{g , t} ) \qquad ( 25 )$$

$${H}_{8 , i , t} = {P}_{8} {\sum }_{g ∈ {G}_{i}} {( {T}_{g , on} {y}_{g , t} - {\sum }_{k = t}^{t + {T}_{g , on} - 1} {u}_{g , k} + {δ}_{1 , g} {\sum }_{l = 0}^{{Y}_{1 , g , t} - 1} {2}^{l} {y}_{1 , g , l}^{add} )}^{2} \qquad ( 26 )$$

$${H}_{9 , i , t} = {P}_{9} {\sum }_{g ∈ {G}_{i}} {( {T}_{g , off} {z}_{g , t} - {\sum }_{k = t}^{t + {T}_{g , off} - 1} ( 1 - {u}_{g , k} ) + {δ}_{2 , g} {\sum }_{l = 0}^{{Y}_{2 , g , t} - 1} {2}^{l} {y}_{2 , g , l}^{add} )}^{2} \qquad ( 27 )$$

$${H}_{10 , i} = {\sum }_{g ∈ {G}_{i}} {{P}_{10} ( {\sum }_{t ∈ T} {y}_{g , t} - {y}_{g , max} + {δ}_{3 , g} {\sum }_{l = 0}^{{Y}_{3 , g} - 1} {2}^{l} {y}_{3 , g , l}^{add} )}^{2} \qquad ( 28 )$$

$${H}_{11 , i} = {P}_{11} {\sum }_{g ∈ {G}_{i}} {{P}_{11} ( {\sum }_{t ∈ T} {z}_{g , t} - {z}_{g , max} + {δ}_{4 , g} {\sum }_{l = 0}^{{Y}_{4 , g} - 1} {2}^{l} {y}_{4 , g , l}^{add} )}^{2} \qquad ( 29 )$$

$${δ}_{k , g} = \frac{{S}_{k}}{{2}^{{Y}_{k , g}} - 1} , k = 1 , 2 , 3 , 4 , S = \{ {T}_{g , on} , {T}_{g , off} , {y}_{g , max} , {z}_{g , max} \} \qquad ( 30 )$$

$${H}_{i} = {\sum }_{t ∈ T} ( \begin{matrix}{H}_{1 , i , t} + {H}_{2 , i , t} + {H}_{3 , i , t} + \\ {H}_{4 , i , t} + {H}_{5 , i , t} + {H}_{6 , i , t} + \\ {H}_{7 , i , t} + {H}_{8 , i , t} + {H}_{9 , i , t}\end{matrix} ) + {H}_{10 , i} + {H}_{11 , i} \qquad ( 31 )$$

In formulas (19)-(31), H_{2,i,t}, H_{3,i,t}, H_{4,i,t}, and H_{5,i,t} represent energy functions of the upper and lower limit constraint model of generator unit output and the ramping constraint models of the generator unit, respectively, H_{6,i,t}˜H_{9,i,t}, H_{10,i}, and H_{11,i} represent energy functions of the generator unit operation constraint model, respectively, P₂˜P₁₁ represent corresponding penalty term coefficients, δ_{k,g}, k=1, . . . 4 represents a relaxation term coefficient, and

$${y}_{k , g , l}^{add} , k = 1 , 2 , 3 , 4$$

represents a state value of added discrete variable.

More preferably, in the step 2, the discrete variable solution value is passed to the continuous optimization part for solution as follows:

After a discrete problem is reconstructed, the number of qubits is calculated and mapped to a Q matrix, which is deployed in a quantum computer for solution, and then an evolution result is observed, a Hamiltonian is analyzed, and an analysis result is output.

The treatment of the continuous optimization problem includes: After obtaining the solution to the discrete optimization problem, the solution is passed as a known parameter to the continuous optimization problem, and the continuous optimization problem is solved on a classical computer.

Preferably, the step 3 specifically includes:
After all subproblems have been solved in the k-th iteration, the convergence conditions are checked. If the conditions are met, the iteration terminates and the optimal result is output. If the convergence conditions are not met, after checking whether the optimality conditions are met, update the Lagrange multiplier according to formula (32). If only at least one subproblem in an iteration meets the optimality conditions, an iteration step size and a penalty term coefficient are updated according to formula (33)-(35) based on an intermediate variable result from two adjacent iterations at the k-th iteration. At a later stage, if the penalty term coefficient is too large, the update is performed according to formula (36);

$${λ}_{t}^{k + 1} = {λ}_{t}^{k} + {s}^{k} {g}_{t}^{k} ( {P}_{g , t}^{G} , {P}_{i , t}^{LS} ) \qquad ( 32 )$$

$${s}^{k} = {α}^{k} \frac{{s}^{k - 1} {‖ {g}_{t}^{k - 1} ( {P}_{g , t}^{G} , {P}_{i , t}^{LS} ) ‖}_{2}}{{‖ {g}_{t}^{k} ( {P}_{g , t}^{G} , {P}_{i , t}^{LS} ) ‖}_{2}} , 0 < {α}^{k} < 1 \qquad ( 33 )$$

$${α}^{k} = 1 - \frac{1}{{Mk}^{ρ}} , ρ = 1 - \frac{1}{{k}^{r}} , M \geq 1 , 0 < r < 1 \qquad ( 34 )$$

$${c}^{k + 1} = {c}^{k} \cdot β , β > 1 \qquad ( 35 )$$

$${c}^{k + 1} = {c}^{k} \cdot {β}^{- 1} , β > 1 \qquad ( 36 )$$

In formulas (33)-(36), α^{k} represents a step size parameter, and β represents a preset constant parameter.

More preferably, the output optimal result includes: an operating state result of a generator unit during post-disaster restoration, an output dispatching result of a generator unit, a load shedding result of each node, and a line power flow result. The optimal output result will provide an instruction reference for a power grid dispatcher, enabling the dispatcher to formulate a post-disaster restoration plan within a short time and achieve the effect of accelerating the post-disaster restoration through quantum computing.

The present application has the following beneficial effects:
The present application provides a quantum proxy Lagrangian relaxation algorithm to solve the model. The problem is decomposed into multiple node-centered subproblems, which are further divided into a discrete part and a continuous part for solution, thereby reducing the difficulty of the solution. Moreover, the algorithm can achieve the effects of parallel computing and quantum-embedding accelerated computing without complete optimization for a relaxed problem, and can ensure better convergence.

### BRIEF DESCRIPTION OF THE DRAWINGS

FIG. 1 is a flow chart of the parallel accelerated solution method for post-disaster restoration of the power system based on quantum computing in the present application; and

FIG. 2 is a schematic diagram of the actual application and implementation of the present application.

### DETAILED DESCRIPTION

The techniques in the embodiments of the present application will be clearly and completely described below with reference to the drawings in the embodiments of the present application. Obviously, the embodiments described are only a part of, not all, the embodiments of the present application. Based on the embodiments described herein, all other embodiments obtained by those of ordinary skill in the art without creative work are within the scope of the present application.

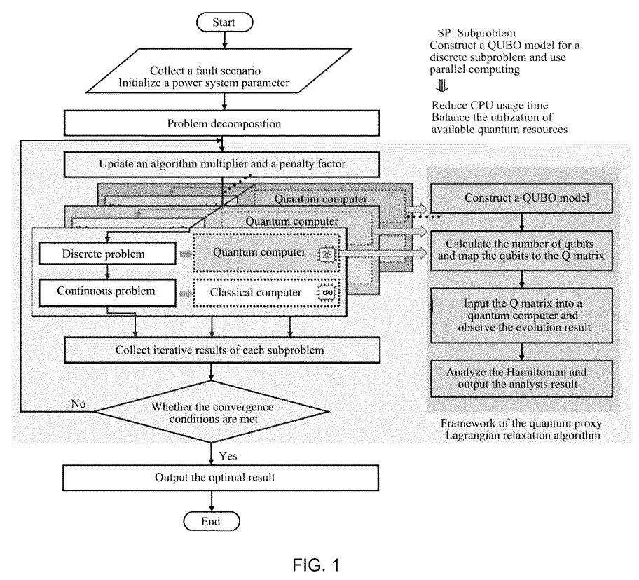

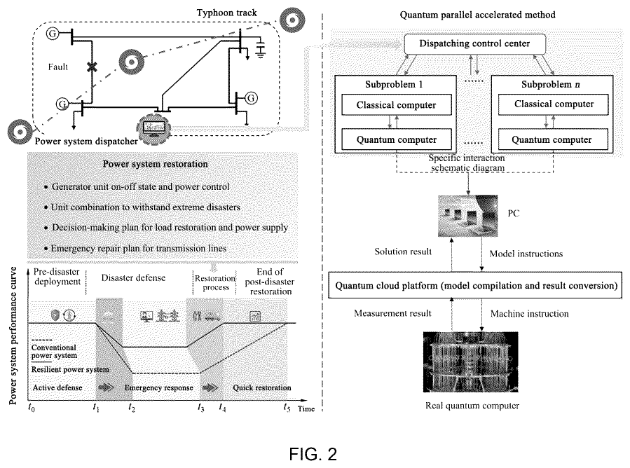

As shown in FIGS. 1-2, the present application provides a parallel accelerated solution method for post-disaster restoration of the power system based on quantum computing. The specific process includes steps 1-3, and the flow chart is shown in FIG. 1.

Step 1: Establish a basic model for post-disaster restoration of the power system, in which the basic model includes: a post-disaster restoration objective function, a system balance and load constraint model, an electric power transmission constraint model, and a generator unit operation constraint model, specifically as follows:

The post-disaster restoration objective function is shown in formula (1), which specifically includes three parts: The first item is the load shedding cost, the second item is the generator unit operating cost, and the third item is the generator unit on-off cost. The model aims to minimize the sum of these three costs.

$$min {\sum }_{t ∈ T} {\sum }_{i ∈ B} {C}_{i , t}^{LS} {w}_{i} {P}_{i , t}^{LS} + {\sum }_{t ∈ T} {\sum }_{i ∈ B} {\sum }_{g ∈ {G}_{i}} {C}_{g , t}^{G} {P}_{g , t}^{G} + {\sum }_{t ∈ T} {\sum }_{i ∈ B} {\sum }_{g ∈ {G}_{i}} {C}_{g , t}^{UC} \vert {u}_{g , t} - {u}_{g , t - 1} \vert \qquad ( 1 )$$

In the formula, T represents a time period set, u_{g,t} represents an on-off 0/1 state variable of unit g at time t,

$${P}_{g , t}^{G}$$

represents an active output power of unit g at time t,

$${P}_{t , t}^{LS}$$

represents an active load shedding of node i at time t,

$${C}_{g , t}^{G}$$

represents a unit operating cost of unit g at time t,

$${C}_{g , t}^{UC}$$

represents a unit on-off cost of unit g at time t,

$${C}_{t , t}^{LS}$$

represents a unit load shedding cost of node i at time t, B represents a power system node set, Gᵢ represents a set of generator units contained under node i, and wᵢ represents the importance coefficient of the power load at the i-th node.

The system balance and load constraint model are as follows: Formula (2) is a system power balance model, and formula (3) is a node load shedding model.

$${\sum }_{i ∈ B} {\sum }_{g ∈ {G}_{i}} {P}_{g , t}^{G} = {\sum }_{i ∈ B} ( {P}_{i , t}^{L} - {P}_{i , t}^{LS} ) , t ∈ T \qquad ( 2 )$$

$$0 \leq {P}_{i , t}^{LS} \leq {P}_{i , t}^{L} , ∀ i ∈ B , t ∈ T \qquad ( 3 )$$

In the two formulas,

$${P}_{i , t}^{L}$$

represents an active load of node i at time t.

The electric power transmission constraint model is as follows: Formula (4) is a power transmission upper and lower limit constraint model of a power line, formula (5) is a power flow constraint model of line ij, formula (6) is a node phase angle upper and lower limit constraint model, and formula (7) is a node power balance constraint model.

$$- {z}_{ij , t} {S}_{ij}^{max} \leq {P}_{ij , t} \leq {z}_{ij , t} {S}_{ij}^{max} , ∀ ( i , j ) ∈ L , t ∈ T \qquad ( 4 )$$

$$- ( 1 - {z}_{ij , t} ) M \leq {P}_{ij , t} - ( {θ}_{i , t} - {θ}_{j , t} ) / {X}_{ij} \leq ( 1 - {z}_{ij , t} ) M , ∀ ( i , j ) ∈ L , t ∈ T \qquad ( 5 )$$

$${θ}_{i , min} \leq {θ}_{i , t} \leq {θ}_{i , max} , ∀ i ∈ B , t ∈ T \qquad ( 6 )$$

$${\sum }_{g ∈ {G}_{i}} {P}_{g , t}^{G} - ( {P}_{i , t}^{L} - {P}_{i , t}^{LS} ) = {\sum }_{j ∈ L ( i , j )} {P}_{ij , t} - {\sum }_{j ∈ L ( j , i )} {P}_{ji , t} , ∀ i ∈ B , t ∈ T \qquad ( 7 )$$

In the above formulas, P_{ij,t} and

$${S}_{ij}^{max}$$

represent active power and maximum transmission power passing through branch ij; M represents a sufficiently large constant; Xᵢⱼ represents reactance of branch ij; θᵢ, θ_{t,min}, and θ_{t,min} represent a phase angle amplitude, minimum phase angle value, and maximum phase angle value of node i, respectively; z_{ij,t} represents the operating state of transmission branch ij at time t; and j∈L (i,j) represents that node j has node i in an upstream node set of node j.

The generator unit operation constraint model is as follows: Formula (8) is an upper and lower limit constraint model of generator unit output, formula (9) and formula (10) are ramping constraint models of the generator unit, and formula (11) to formula (16) are operating state constraint models of the generator unit.

$${u}_{g , t} {P}_{g , min}^{G} \leq {P}_{g , t}^{G} \leq {u}_{g , t} {P}_{g , max}^{G} , ∀ g ∈ {G}_{i} , i ∈ B , t ∈ T \qquad ( 8 )$$

$${P}_{g , t}^{G} - {P}_{g , t - 1}^{G} \leq {RU}_{g} {u}_{g , t - 1} + {RSU}_{g} {y}_{g , t} , ∀ g ∈ {G}_{i} , i ∈ B , t ∈ T \qquad ( 9 )$$

$${P}_{g , t - 1}^{G} - {P}_{g , t}^{G} \leq {RD}_{g} {u}_{g , t} + {RSD}_{g} {z}_{g , t} , ∀ g ∈ {G}_{i} , i ∈ B , t ∈ T \qquad ( 10 )$$

$${y}_{g , t} - {z}_{g , t} = {u}_{g , t} - {u}_{g , t - 1} , ∀ g ∈ {G}_{i} , i ∈ B , ∀ t ∈ T \qquad ( 11 )$$

$${y}_{g , t} + {z}_{g , t} \leq 1 , ∀ g ∈ {G}_{i} , i ∈ B , ∀ t ∈ T \qquad ( 12 )$$

$${\sum }_{k = t}^{t + {T}_{g , on} - 1} {u}_{g , k} \geq {T}_{g , on} {y}_{g , t} , ∀ g ∈ {G}_{i} , i ∈ B , t ∈ \{ 1 , 2 , … , T - {T}_{g , on} + 1 \} \qquad ( 13 )$$

$${\sum }_{k = t}^{t + {T}_{g , off} - 1} ( 1 - {u}_{g , k} ) \geq {T}_{g , off} {z}_{g , t} , ∀ g ∈ {G}_{i} , \qquad ( 14 )$$

$$i ∈ B , t ∈ \{ 1 , 2 , … , T - {T}_{g , off} + 1 \}$$

$${\sum }_{t ∈ T} {y}_{g , t} \leq {y}_{g , max} , ∀ g ∈ {G}_{i} , i ∈ B \qquad ( 15 )$$

$${\sum }_{t ∈ T} {z}_{g , t} \leq {z}_{g , max} , ∀ g ∈ {G}_{i} , i ∈ B \qquad ( 16 )$$

In the above formulas,

$${P}_{g , min}^{G} and {P}_{g , max}^{G}$$

represent maximum and minimum values of output of unit g, respectively, RU_{g}, RD_{g} represent ramp rates of power increase/decrease during normal operation of generator unit g, RSU_{g}, RSD_{g} represent on/off ramp rates of unit g, respectively, y_{g,t}, z_{g,t} represent on/off action variables of unit g at time t, y_{g,max}, z_{g,max} represent the maximum number of on/off actions of unit g, and T_{g,on} and T_{g,off} represent a minimum on duration and a minimum off duration of unit g, respectively.

Step 2: According to the quantum proxy Lagrangian relaxation algorithm, decompose an original optimization problem into each node subproblem. In each node subproblem, first construct a discrete optimization part into a quantum model for solution, and then pass a discrete variable solution value to a continuous optimization part for solution.

The original optimization problem will be decomposed into the following subproblems represented by nodes,

$${min}_{{{{P}_{i , t}^{LS} , {P}_{g , t}^{G}}_{{u}_{g , t} , {y}_{g , t} , {z}_{g , t}}}_{{P}_{ij , t} , {θ}_{i , t}}} \{ \begin{matrix}{\sum }_{t ∈ T} {C}_{i , t}^{LS} {w}_{i} {P}_{i , t}^{LS} + {\sum }_{t ∈ T} {\sum }_{g ∈ {G}_{i}} {C}_{g , t}^{G} {P}_{g , t}^{G} + \\ {\sum }_{t ∈ T} {\sum }_{g ∈ {G}_{i}} {C}_{g , t}^{UC} \vert {u}_{g , t} - {u}_{g , t - 1} \vert + \\ {\sum }_{t ∈ T} {λ}_{t}^{k} {g}_{t}^{k} ( {P}_{g , t}^{G} , {P}_{i , t}^{LS} ) + \frac{{c}^{k}}{2} {\sum }_{t ∈ T} {q}_{t} + \\ {c}^{P} {\sum }_{t ∈ Tij ∈ L} {\sum }_{( i , j ) ⋃ L ( j , i )} ( {P}_{ij , t}^{i , k} - ( {P}_{ij , t}^{i , k - 1} + {P}_{ij , t}^{j , k - 1} ) / 2 )\end{matrix} \} \qquad ( 17 )$$

$$s . t . Generator unit operation constraint ( 3 ) , ( 7 ) , ( 8 \text{)-(} 16 ) t ∈ T$$

$$Electric power transmission constrai nt ( 4 \text{)-(} 6 ) , ∀ ( i , j ) ∈ L , t ∈ \text{?}$$

$$- {q}_{t} \leq {g}_{t}^{k} ( {P}_{g , t}^{G} , {P}_{i , t}^{LS} ) \leq {q}_{t} , t ∈ T$$

$$\text{?} \text{indicates text missing or illegible when filed}$$

In the formula,

$${λ}_{t}^{k}$$

represents a Lagrange multiplier corresponding to time t under iteration k, and qₜ represents a continuous variable added by the relaxation term at time t. c^{k} and c^{P} represent penalty term coefficients.

The relaxation term

$${g}_{t}^{k} ( {P}_{g , t}^{G} , {P}_{i , t}^{LS} )$$

can be written as follows,

$${g}_{t}^{k} ( {P}_{g , t}^{G} , {P}_{i , t}^{LS} ) = {\sum }_{g ∈ {G}_{i}} {P}_{g , t}^{G , k} - ( {P}_{i , t}^{L} - {P}_{i , t}^{LS , k} ) + {\sum }_{{i}^{′} ∈ {B}_{- i}} {\sum }_{g ∈ {G}_{i \text{?}}} {P}_{g , t}^{G , k - 1} - {\sum }_{{i}^{′} ∈ {B}_{- i}} ( {P}_{{i}^{′} , t}^{L} - {P}_{{i}^{′} , t}^{LS , k - 1} ) , t ∈ T \qquad ( 18 )$$

$$\text{?} \text{indicates text missing or illegible when filed}$$

The above subproblems of each node are further divided into a discrete optimization problem and a continuous optimization problem. The treatment of the discrete problem is: reconstructing the constrained optimization model into a Quadratic Unconstrained Binary Optimization (QUBO) model, and converting the constraints into multiple penalty terms in the objective function. The details are as follows:

$${H}_{1 , i , t} = {\sum }_{g ∈ {G}_{i}} {C}_{g , t}^{UC} ( {u}_{g , t} + {u}_{g , t - 1} - 2 {u}_{g , t} {u}_{g , t - 1} ) \qquad ( 19 )$$

$${H}_{2 , i , t} = {P}_{2} {\sum }_{g ∈ {G}_{i}} {( {u}_{g , t} {P}_{g , min}^{G} - {P}_{g , t}^{T} + {ξ}_{\underline{1} , g , t} )}^{2} \qquad ( 20 )$$

$${H}_{3 , i , t} = {P}_{3} {\sum }_{g ∈ {G}_{i}} {( {P}_{g , t}^{G} - {u}_{g , t} {P}_{g , max}^{G} + {ξ}_{\overline{1} , g , t} )}^{2} \qquad ( 21 )$$

$${H}_{4 , i , t} = {P}_{4} {\sum }_{g ∈ {G}_{i}} {( {P}_{g , t}^{G} - {P}_{g , t - 1}^{G} - {RU}_{g} {u}_{g , t - 1} - {RSU}_{g} {y}_{g , t} + {ξ}_{2 , g , t} )}^{2} \qquad ( 22 )$$

$${H}_{5 , i , t} = {P}_{5} {\sum }_{g ∈ {G}_{i}} {( {P}_{g , t - 1}^{G} - {P}_{g , t}^{G} - {RD}_{g} {u}_{g , t} - {RSD}_{g} {y}_{g , t} + {ξ}_{3 , g , t} )}^{2} \qquad ( 23 )$$

$${H}_{6 , i , t} = {P}_{6} {\sum }_{g ∈ {G}_{i}} {( {y}_{g , t} - {z}_{g , t} - {u}_{g , t} + {u}_{g , t - 1} )}^{2} \qquad ( 24 )$$

$${H}_{7 , i , t} = {P}_{7} {\sum }_{g ∈ {G}_{i}} ( {y}_{g , t} {z}_{g , t} ) \qquad ( 25 )$$

$${H}_{8 , i , t} = {P}_{8} {\sum }_{g ∈ {G}_{i}} {( {T}_{g , on} {y}_{g , t} - {\sum }_{k = t}^{t + {T}_{g , on} - 1} {u}_{g , k} + {δ}_{1 , g} {\sum }_{l = 0}^{{Y}_{1 , g , t} - 1} {2}^{l} {y}_{1 , g , l}^{add} )}^{2} \qquad ( 26 )$$

$${H}_{9 , i , t} = {P}_{9} {\sum }_{g ∈ {G}_{i}} {( {T}_{g , off} {z}_{g , t} - {\sum }_{k = t}^{t + {T}_{g , off} - 1} ( 1 - {u}_{g , k} ) + {δ}_{2 , g} {\sum }_{l = 0}^{{Y}_{2 , g , t} - 1} {2}^{l} {y}_{2 , g , l}^{add} )}^{2} \qquad ( 27 )$$

$${H}_{10 , i} = {\sum }_{g ∈ {G}_{i}} {{P}_{10} ( {\sum }_{t ∈ T} {y}_{g , t} - {y}_{g , max} + {δ}_{3 , g} {\sum }_{l = 0}^{{Y}_{3 , g} - 1} {2}^{l} {y}_{3 , g , l}^{add} )}^{2} \qquad ( 28 )$$

$${H}_{11 , i} = {\sum }_{g ∈ {G}_{i}} {{P}_{11} ( {\sum }_{t ∈ T} {z}_{g , t} - {z}_{g , max} + {δ}_{4 , g} {\sum }_{l = 0}^{{Y}_{4 , g} - 1} {2}^{l} {y}_{4 , g , l}^{add} )}^{2} \qquad ( 29 )$$

$${δ}_{k , g} = \frac{{S}_{k}}{{2}^{{Y}_{k , g}} - 1} , k = 1 , 2 , 3 , 4 , S = \{ {T}_{g , on} , {T}_{g , off} , {y}_{g , max} , {z}_{g , max} \} \qquad ( 30 )$$

$${H}_{i} = {\sum }_{t ∈ T} ( \begin{matrix}{H}_{1 , i , t} + {H}_{2 , i , t} + {H}_{3 , i , t} + \\ {H}_{4 , i , t} + {H}_{5 , i , t} + {H}_{6 , i , t} + \\ {H}_{7 , i , t} + {H}_{8 , i , t} + {H}_{9 , i , t}\end{matrix} ) + {H}_{10 , i} + {H}_{11 , i} \qquad ( 31 )$$

In the foregoing formulas, H_{2,i,t}, H_{3,i,t}, H_{4,i,t}, and H_{5,i,t} represent energy functions of the upper and lower limit constraint model of generator unit output and the ramping constraint models of the generator unit in formula (8)-(10), H_{6,i,t}˜H_{9,i,t}, H_{10,i}, and H_{11,i} represent energy functions of the generator unit operation constraint model, P₂˜P₁₁ represents corresponding penalty term coefficients, δ_{k,g}, k=1, . . . 4 represents a relaxation term coefficient, and

$${y}_{k , g , l}^{add} , k = 1 , 2 , 3 , 4$$

represents a state value of added discrete variable.

After a discrete problem is reconstructed, the number of qubits is calculated and mapped to a Q matrix, which is deployed in a quantum computer for solution, and then an evolution result is observed, a Hamiltonian is analyzed, and an analysis result is output.

The treatment of the continuous optimization problem is: After the solution to the discrete optimization problem is obtained, the solution is passed as a known parameter to the continuous optimization problem, and the continuous optimization problem is solved on a classical computer.

Step 3: Use the quantum proxy Lagrangian relaxation algorithm to solve the model for post-disaster restoration, continuously update parameters such as a Lagrange multiplier, a penalty factor in an iteration process, achieve an optimal solution under interactive computation of quantum computing and classical computing, and accelerate the acquisition of a post-disaster restoration plan to guide an actual safe operation of the power system.

Specifically, in the k-th iteration, after all subproblems have been solved, the convergence conditions are checked. If the convergence conditions are met, the iteration terminates, and the optimal result is output. If the convergence conditions are not met, after checking whether the optimality conditions are met, update the Lagrange multiplier according to formula (32). If only at least one subproblem in an iteration meets the optimality conditions, the iteration step size and penalty term coefficient are updated according to formula (33)-(35) based on the intermediate variable results from two adjacent iterations at the k-th iteration. At a later stage, if the penalty term coefficient is too large, the update is performed according to formula (36).

$${λ}_{t}^{k + 1} = {λ}_{t}^{k} + {s}^{k} {g}_{t}^{k} ( {P}_{g , t}^{G} , {P}_{i , t}^{LS} ) \qquad ( 32 )$$

$${s}^{k} = {α}^{k} \frac{{s}^{k - 1} {‖ {g}_{t}^{k - 1} ( {P}_{g , t}^{G} , {P}_{i , t}^{LS} ) ‖}_{2}}{{‖ {g}_{t}^{k} ( {P}_{g , t}^{G} , {P}_{i , t}^{LS} ) ‖}_{2}} , 0 < {α}^{k} < 1 \qquad ( 33 )$$

$${α}^{k} = 1 - \frac{1}{{Mk}^{ρ}} , ρ = 1 - \frac{1}{{k}^{r}} , M \geq 1 , 0 < r < 1 \qquad ( 34 )$$

$${c}^{k + 1} = {c}^{k} \cdot β , β > 1 \qquad ( 35 )$$

$${c}^{k + 1} = {c}^{k} \cdot {β}^{- 1} , β > 1 \qquad ( 36 )$$

In the above formulas, α^{k} represents a step size parameter and β represents a preset constant parameter.

The schematic flow chart is shown in FIG. 1. The optimal output result includes: an operating state result of a generator unit during post-disaster restoration, an output dispatching result of a generator unit, a load shedding result of each node, and a line power flow result. The optimal output result will provide an instruction reference for a power grid dispatcher, enabling the dispatcher to formulate a post-disaster restoration plan within a short time and achieve the effect of accelerating the post-disaster restoration through quantum computing.

### Embodiment

This embodiment takes a wind disaster as an example. As shown in FIG. 2, after a model and an algorithm are built, in order to realize the interaction between quantum computing and classical computing to accelerate post-disaster restoration of a power system, the actual application process and schematic plan are as follows:

Step 1: After a typhoon disaster occurs, confirm an initial state parameter of the fault as soon as possible and take the parameter as input data for the above model. Each power node confirms the connection state between a classical computer and a quantum computer.

Step 2: Each power node interacts with a power dispatching control center to monitor the fault repair process at each moment, and forms a sub-optimization problem based on the power node. After the discrete problem in the sub-optimization problem is transformed by the quantum model, the discrete problem is first transmitted from a PC to a quantum cloud platform, and calls a real quantum computer to return the calculation result, and then the intermediate result is transmitted to the continuous problem for further optimization and solution.

Step 3: An iterative solution is performed according to the quantum proxy Lagrangian relaxation algorithm. After meeting the convergence conditions, the operating state result of a generator unit during post-disaster restoration, the output dispatching result of a generator unit, the load shedding result of each node, and the line power flow result are output. After confirming that the optimization result is safe and reasonable, an actual power dispatching instruction is issued to control the operation of the power system and support rapid post-disaster restoration.

Finally, after the post-disaster restoration of the power system is completed, the computational efficiency and performance of quantum computing are evaluated, and the experience of post-disaster power dispatching and the plan evaluation are summarized. The present application reconstructs the constrained optimization model into a Quadratic Unconstrained Binary Optimization (QUBO) model for the discrete problem, providing a reference for converting a post-disaster restoration problem model into a quantum model. The process of the quantum proxy Lagrangian relaxation algorithm in the present application can realize parallel computing of subproblems and accelerated solution of quantum computing.

In summary, the present application provides a quantum proxy Lagrangian relaxation algorithm to solve the model. The problem is decomposed into multiple node-centered subproblems, which are further divided into a discrete part and a continuous part for solution, thereby reducing the difficulty of the solution. Moreover, the algorithm can realize the effects of parallel computing and quantum-embedding accelerated computing without complete optimization for a relaxed problem, and can ensure better convergence. Therefore, the present application has broad application prospects in the fields of rapid restoration of power supply after a power system is damaged by a disaster, rational and efficient dispatch and control, and coordinated optimization.

It should be emphasized that the above descriptions are merely preferred embodiments of the present application and are not intended to limit the present application in any form. Any simple modifications, equivalent changes, and modifications made to the above embodiments based on the technical essence of the present application still fall within the scope of the technical solution of the present application.

What is claimed is:

1. A parallel accelerated solution method for post-disaster restoration of a power system based on quantum computing, comprising:
step 1: establishing a basic model for post-disaster restoration of the power system, wherein the basic model comprises: a post-disaster restoration objective function, a system balance and load constraint model, an electric power transmission constraint model, and a generator unit operation constraint model;
step 2: according to a quantum proxy Lagrangian relaxation algorithm, decomposing an original optimization problem into each node subproblem, wherein in the each node subproblem, first constructing a discrete optimization part into a quantum model for solution, and then passing a discrete variable solution value to a continuous optimization part for solution; and
step 3: using the quantum proxy Lagrangian relaxation algorithm to solve a post-disaster restoration model, continuously updating, in an iteration process, a Lagrange multiplier, a penalty factor, and intermediate variable optimization results of discrete optimization and continuous optimization subproblems, achieving an optimal solution under interactive computation of quantum computing and classical computing, and accelerating an acquisition of a post-disaster restoration plan to guide an actual safe operation of the power system;
wherein in the step 1, the post-disaster restoration objective function is:
$$min {\sum }_{t ∈ T} {\sum }_{i ∈ B} {C}_{i , t}^{LS} {w}_{i} {P}_{i , t}^{LS} + {\sum }_{t ∈ T} {\sum }_{i ∈ B} {\sum }_{g ∈ {G}_{i}} {C}_{g , t}^{G} {P}_{g , t}^{G} + {\sum }_{t ∈ T} {\sum }_{i ∈ B} {\sum }_{g ∈ {G}_{i}} {C}_{g , t}^{UC} \vert {u}_{g , t} - {u}_{g , t - 1} \vert \qquad ( 1 )$$
wherein, in formula (1), T represents a time period set, u_{j,t} represents an on-off 0/1 state variable of unit g at time t,
$${P}_{g , t}^{G}$$
represents an active output power of unit g at time t,
$${P}_{i , t}^{LS}$$
represents an active load shedding of node i at time t,
$${C}_{g , t}^{G}$$
represents a unit operating cost of unit g at time t,
$${C}_{g , t}^{UC}$$
represents a unit on-off cost of unit g at time t,
$${C}_{i , t}^{LS}$$
represents a unit load shedding cost of node i at time t, B represents a power system node set, Gᵢ represents a set of generator units contained under node i, and wᵢ represents the importance coefficient of the power load at the i-th node; and
in the step 2, the passing a discrete variable solution value to a continuous optimization part for solution specifically comprises:
after a discrete problem is reconstructed, calculating the number of qubits and mapping the qubits to a Q matrix, deploying the Q matrix in a quantum computer for solution, observing an evolution result, analyzing a Hamiltonian, and outputting an analysis result;
wherein, a treatment of a continuous optimization problem comprises: obtaining the solution to the discrete optimization problem, then passing the solution as a known parameter to the continuous optimization problem, and solving the continuous optimization problem on a classical computer.

2. The parallel accelerated solution method for the post-disaster restoration of the power system based on the quantum computing according to claim 1, wherein in the step 1, the system balance and load constraint model is:
$${\sum }_{i ∈ B} {\sum }_{g ∈ {G}_{i}} {P}_{g , t}^{G} = {\sum }_{i ∈ B} ( {P}_{i , t}^{L} - {P}_{i , t}^{LS} ) , t ∈ T \qquad ( 2 )$$
$$0 \leq {P}_{i , t}^{LS} \leq {P}_{i , t}^{L} , ∀ i ∈ B , t ∈ T \qquad ( 3 )$$
wherein, in formula (2) and formula (3),
$${P}_{i , t}^{L}$$
represents an active load of node i at time t, formula (2) is a system power balance model, and formula (3) is a node load shedding model.

3. The parallel accelerated solution method for the post-disaster restoration of the power system based on the quantum computing according to claim 2, wherein in the step 1, the electric power transmission constraint model is:
$$- {z}_{ij , t} {S}_{ij}^{max} \leq {P}_{ij , t} \leq {z}_{ij , t} {S}_{ij}^{max} , ∀ ( i , j ) ∈ L , t ∈ T \qquad ( 4 )$$
$$- ( 1 - {z}_{ij , t} ) M \leq {P}_{ij , t} - ( {θ}_{i , t} - {θ}_{j , t} ) / {X}_{ij} \leq ( 1 - {z}_{ij , t} ) M , ∀ ( i , j ) ∈ L , t ∈ T \qquad ( 5 )$$
$${θ}_{i , mi n} \leq {θ}_{i , t} \leq {θ}_{i , max} , ∀ i ∈ B , t ∈ T \qquad ( 6 )$$
$${\sum }_{g ∈ {G}_{i}} {P}_{g , t}^{G} - ( {P}_{i , t}^{L} - {P}_{i , t}^{LS} ) = {\sum }_{j ∈ L ( i , j )} {P}_{ij , t} - {\sum }_{j ∈ L ( j , i )} {P}_{ji , t} , ∀ i ∈ B , t ∈ T \qquad ( 7 )$$
wherein, in formulas (4)-(7), P_{ij,t} and
$${S}_{ij}^{max}$$
represent an active power and maximum transmission power passing through branch ij, M represents a sufficiently large constant, Xᵢⱼ represents reactance of branch ij, θᵢ, θ_{i,min}, and θ_{i,max} represent a phase angle amplitude, minimum phase angle value, and maximum phase angle value of node i, respectively, z_{ij,t}, represents the operating state of transmission branch ij at time t, and j∈L (i, j) represents that node j has node i in an upstream node set of node j; and formula (4) is a power transmission upper and lower limit constraint model of a power line, formula (5) is a power flow constraint model of line ij, formula (6) is a node phase angle upper and lower limit constraint model, and formula (7) is a node power balance constraint model.

4. The parallel accelerated solution method for the post-disaster restoration of the power system based on the quantum computing according to claim 3, wherein the generator unit operation constraint model is:
$${u}_{g , t} {P}_{g , min}^{G} \leq {P}_{g , t}^{G} \leq {u}_{g , t} {P}_{g , max}^{G} , ∀ g ∈ {G}_{i} , i ∈ B , t ∈ T \qquad ( 8 )$$
$${P}_{g , t}^{G} - {P}_{g , t - 1}^{G} \leq {RU}_{g} {u}_{g , t - 1} + {RSU}_{g} {y}_{g , t} , ∀ g ∈ {G}_{i} , i ∈ B , t ∈ T \qquad ( 9 )$$
$${P}_{g , t - 1}^{G} - {P}_{g , t}^{G} \leq {RD}_{g} {u}_{g , t} + {RSD}_{g} {z}_{g , t} , ∀ g ∈ {G}_{i} , i ∈ B , t ∈ T \qquad ( 10 )$$
$${y}_{g , t} - {z}_{g , t} = {u}_{g , t} - {u}_{g , t - 1} , ∀ g ∈ {G}_{i} , i ∈ B , t ∈ T \qquad ( 11 )$$
$${y}_{g , t} + {z}_{g , t} \leq 1 , ∀ g ∈ {G}_{i} , i ∈ B , t ∈ T \qquad ( 12 )$$
$${\sum }_{k = t}^{t + {T}_{g , on} - 1} {u}_{g , k} \geq {T}_{g , on} {y}_{g , t} , ∀ g ∈ {G}_{i} , i ∈ B , t ∈ \{ 1 , 2 , … , T - {T}_{g , on} + 1 \} \qquad ( 13 )$$
$${\sum }_{k = t}^{t + {T}_{g , off} - 1} ( 1 - {u}_{g , k} ) \geq {T}_{g , off} {z}_{g , t} , ∀ g ∈ {G}_{i} , i ∈ B , t ∈ \{ 1 , 2 , … , T - {T}_{g , off} + 1 \} \qquad ( 14 )$$
$${\sum }_{t ∈ T} {y}_{g , t} \leq {y}_{g , max} , ∀ g ∈ {G}_{i} , i ∈ B \qquad ( 15 )$$
$${\sum }_{t ∈ T} {z}_{g , t} \leq {z}_{g , max} , ∀ g ∈ {G}_{i} , i ∈ B \qquad ( 16 )$$
wherein, in formulas (8)-(16),
$${P}_{g , min}^{G} and {P}_{g , max}^{G}$$
represent maximum and minimum values of output of unit g, respectively, RU_{g}, RD_{g} represent a ramp rate of power increase/decrease during normal operation of generator unit g, respectively, RSU_{g}, RSD_{g} represent on/off ramp rates of unit g, respectively, y_{g,t}, z_{g,t} represent on/off action variables of unit g at time t, respectively, y_{g,max}, z_{g,max} represent the maximum number of on/off actions of unit g, respectively, and T_{g,on} and T_{g,off} represent a minimum on duration and minimum off duration of unit g, respectivelyi; and formula (8) is an upper and lower limit constraint model of generator unit output, formula (9) and formula (10) are ramping constraint models of the generator unit, and formulas (11)-(16) are operating state constraint models of the generator unit.

5. The parallel accelerated solution method for the post-disaster restoration of the power system based on the quantum computing according to claim 4, wherein in the step 2, the decomposing an original optimization problem into each node subproblem specifically comprises:
decomposing the original optimization problem into the subproblems represented by the following nodes:
$${{{min}_{{P}_{i , t}^{LS} , {P}_{g , t}^{G}}}_{{u}_{g , t} , {y}_{g , t} , {z}_{g , t}}}_{{P}_{ij , t} , {θ}_{i , t}} \{ \begin{matrix}{\sum }_{t ∈ T} {C}_{i , t}^{LS} {w}_{i} {P}_{i , t}^{LS} + {\sum }_{t ∈ T} {\sum }_{g ∈ {G}_{i}} {C}_{g , t}^{G} {P}_{g , t}^{G} \\ + {\sum }_{t ∈ T} {\sum }_{g ∈ {G}_{i}} {C}_{g , t}^{UC} \vert {u}_{g , t} - {u}_{g , t - 1} \vert \\ + {\sum }_{t ∈ T} {λ}_{t}^{k} {g}_{t}^{k} ( {P}_{g , t}^{G} , {P}_{i , t}^{LS} ) + \frac{{c}^{k}}{2} {\sum }_{t ∈ T} {q}_{t} \\ + {c}^{P} {\sum }_{t ∈ Tij ∈ L} {\sum }_{( i , j ) ⌣ L ( i , j )} ( {P}_{ij , t}^{i , k} - ( {P}_{ij , t}^{i , k - 1} + {P}_{ij , t}^{j , k - 1} ) / 2 )\end{matrix} \} \qquad ( 17 )$$
$$s . t . Generator unit operation constraint ( 3 ) , ( 7 ) , ( 8 ) - ( 16 ) t ∈ T$$
$$Electric power transmission constraint ( 4 ) - ( 6 ) , ∀ ( i , j ) ∈ L , t ∈ T - {q}_{t} \leq {g}_{t}^{k} ( {P}_{g , t}^{G} , {P}_{i , t}^{LS} ) \leq {q}_{t} , t ∈ T$$
$${g}_{t}^{k} ( {P}_{g , t}^{G} , {P}_{i , t}^{LS} ) = {\sum }_{g ∈ {G}_{i}} {P}_{g , t}^{G , k} - ( {P}_{i , t}^{L} - {P}_{i , t}^{LS , k} ) + {\sum }_{{i}^{′} ∈ {B}_{- i}} {\sum }_{g ∈ {G}_{i}^{′}} {P}_{g , t}^{G , k - 1} - {\sum }_{{i}^{′} ∈ {B}_{- i}} ( {P}_{{i}^{′} , t}^{L} - {P}_{{i}^{′} , t}^{LS , k - 1} ) , t ∈ T \qquad ( 18 )$$
wherein, in formula (17) and formula (18),
$${λ}_{t}^{k}$$
represents a Lagrange multiplier corresponding to time t under a k-th iteration, qₜ represents a continuous variable added by a relaxation term at time t, c^{k} and c^{P} represent penalty term coefficients, respectively, and
$${g}_{t}^{k} ( {P}_{g , t}^{G} , {P}_{i , t}^{LS} )$$
represents the relaxation term in formula (18).

6. The parallel accelerated solution method for the post-disaster restoration of the power system based on the quantum computing according to claim 5, wherein in the step 2, the constructing a discrete optimization part into a quantum model for solution specifically comprises:
reconstructing an optimization model with a constraint into a Quadratic Unconstrained Binary Optimization model, and converting the constraint into multiple penalty terms in the objective function, specifically as follows:
$${H}_{1 , i , t} = {\sum }_{g ∈ {G}_{i}} {C}_{g , t}^{UC} ( {u}_{g , t} + {u}_{g , t - 1} - 2 {u}_{g , t} {u}_{g , t - 1} ) \qquad ( 19 )$$
$${H}_{2 , i , t} = {P}_{2} {\sum }_{g ∈ {G}_{i}} {( {u}_{g , t} {P}_{g , min}^{G} - {P}_{g , t}^{G} + {ξ}_{1 , g , t} )}^{2} \qquad ( 20 )$$
$${H}_{3 , i , t} = {P}_{3} {\sum }_{g ∈ {G}_{i}} {( {P}_{g , t}^{G} - {u}_{g , t} {P}_{g , max}^{G} + {ξ}_{1 , g , t} )}^{2} \qquad ( 21 )$$
$${H}_{4 , i , t} = {P}_{4} {\sum }_{g ∈ {G}_{i}} {( {P}_{g , t}^{G} - {P}_{g , t - 1}^{G} - {RU}_{g} {u}_{g , t - 1} - {RSU}_{g} {y}_{g , t} + {ξ}_{2 , g , t} )}^{2} \qquad ( 22 )$$
$${H}_{5 , i , t} = {P}_{5} {\sum }_{g ∈ {G}_{i}} {( {P}_{g , t - 1}^{G} - {P}_{g , t}^{G} - {RD}_{g} {u}_{g , t} - {RSD}_{g} {z}_{g , t} + {ξ}_{3 , g , t} )}^{2} \qquad ( 23 )$$
$${H}_{6 , i , t} = {P}_{6} {\sum }_{g ∈ {G}_{i}} {( {y}_{g , t} - {z}_{g , t} - {u}_{g , t} + {u}_{g , t - 1} )}^{2} \qquad ( 24 )$$
$${H}_{7 , i , t} = {P}_{7} {\sum }_{g ∈ {G}_{i}} ( {y}_{g , t} {z}_{g , t} ) \qquad ( 25 )$$
$${H}_{8 , i , t} = {P}_{8} {\sum }_{g ∈ {G}_{i}} {( {T}_{g , o n} {y}_{g , t} - {\sum }_{k = t}^{t + {T}_{g , on} - 1} {u}_{g , k} + {δ}_{1 , g} {\sum }_{l = t}^{{Y}_{1 , g , t} - 1} {2}^{l} {y}_{1 , g , l}^{add} )}^{2} \qquad ( 26 )$$
$${H}_{9 , i , t} = {P}_{9} {\sum }_{g ∈ {G}_{i}} {( {T}_{g , o n} {z}_{g , t} - {\sum }_{k = t}^{t + {T}_{g , off} - 1} ( 1 - {u}_{g , k} ) + {δ}_{2 , g} {\sum }_{l = 0}^{{Y}_{2 , g , t} - 1} {2}^{l} {y}_{2 , g , l}^{add} )}^{2} \qquad ( 27 )$$
$${H}_{10 , i} = {\sum }_{g ∈ {G}_{i}} {{P}_{10} ( {\sum }_{t ∈ T} {y}_{g , t} - {y}_{g , max} + {δ}_{3 , g} {\sum }_{l = 0}^{{Y}_{3 , g} - 1} {2}^{l} {y}_{3 , g , l}^{add} )}^{2} \qquad ( 28 )$$
$${H}_{11 , i} = {\sum }_{g ∈ {G}_{i}} {{P}_{11} ( {\sum }_{t ∈ T} {z}_{g , t} - {z}_{g , max} + {δ}_{4 , g} {\sum }_{l = 0}^{{Y}_{4 , g} - 1} {2}^{l} {y}_{4 , g , l}^{add} )}^{2} \qquad ( 29 )$$
$${δ}_{k , g} = \frac{{S}_{k}}{{2}^{{Y}_{k , g}} - 1} , k = 1 , 2 , 3 , 4 , S = \{ {T}_{g , o n} , {T}_{g , off} , {y}_{g , max} , {z}_{g , max} \} \qquad ( 30 )$$
$${H}_{i} = {\sum }_{t ∈ T} ( \begin{matrix}{H}_{1 , i , t} + {H}_{2 , i , t} + {H}_{3 , i , t} \\ + {H}_{4 , i , t} + {H}_{5 , i , t} + {H}_{6 , i , t} \\ + {H}_{7 , i , t} + {H}_{8 , i , t} + {H}_{9 , i , t}\end{matrix} ) + {H}_{10 , i} + {H}_{11 , i} \qquad ( 31 )$$
wherein, in formulas (19)-(31), H_{2,i,t}, H_{3,i,t}, H_{4,i,t} and H_{5,i,t} represent energy functions of the upper and lower limit constraint model of generator unit output and the ramping constraint models of the generator unit, respectively, H_{6,i,t}˜H_{9,i,t}, H_{10,i,t}, and H_{11,i} represent energy functions of the generator unit operation constraint model, respectively, P₂˜P₁₁ represent corresponding penalty term coefficients, δ_{k,g}, k=1, . . . , 4 represents a relaxation term coefficient, and
$${y}_{k , g , l}^{add} , k = 1 , 2 , 3 , 4$$
represents a state value of added discrete variable.

7. The parallel accelerated solution method for the post-disaster restoration of the power system based on the quantum computing according to claim 6, wherein the step 3 specifically comprises:
after all subproblems have been solved in the k-th iteration, checking whether convergence conditions are met; if the convergence conditions are met, terminating the iteration and outputting the optimal solution; if the convergence conditions are not met, after checking whether optimality conditions are met, updating the Lagrange multiplier according to formula (32); if only at least one subproblem in an iteration meets the optimality conditions, updating an iteration step size and a penalty term coefficient according to formula (33)-(35) based on an intermediate variable result from two adjacent iterations at the k-th iteration; and if the penalty term coefficient is too large at a later stage, further updating according to formula (36);
$${λ}_{t}^{k + 1} = {λ}_{t}^{k} + {s}^{k} {g}_{t}^{k} ( {P}_{g , t}^{G} , {P}_{i , t}^{LS} ) \qquad ( 32 )$$
$${s}^{k} = {α}^{k} \frac{{s}^{k - 1} {‖ {g}_{t}^{k - 1} ( {P}_{g , t}^{G} , {P}_{i , t}^{LS} ) ‖}_{2}}{{‖ {g}_{t}^{k} ( {P}_{g , t}^{G} , {P}_{i , t}^{LS} ) ‖}_{2}} , 0 < {α}^{k} < 1 \qquad ( 33 )$$
$${α}^{k} = 1 - \frac{1}{{Mk}^{ρ}} , ρ = 1 - \frac{1}{{k}^{r}} , M \geq 1 , 0 < r < 1 \qquad ( 34 )$$
$${c}^{k + 1} = {c}^{k} \cdot β , β > 1 \qquad ( 35 )$$
$${c}^{k + 1} = {c}^{k} \cdot {β}^{- 1} , β > 1 \qquad ( 36 )$$
wherein, in formulas (33)-(36), α^{k} represents a step size parameter, and β represents a preset constant parameter.

8. The parallel accelerated solution method for the post-disaster restoration of the power system based on the quantum computing according to claim 7, wherein the outputting the optimal solution comprises: an operating state result of a generator unit during post-disaster restoration, an output dispatching result of a generator unit, a load shedding result of each node, and a line power flow result.
